(19) United States
(12) Patent Application Publication
(10) Pub. No.: US 2008/0047659 A1
(43) Pub. Date: Feb. 28, 2008

(54) Method for manufacturing single panel reattachable pant

(75) Inventor: Stacy Driskell, Royersford, PA (US)

Correspondence Address: GOSZ AND PARTNERS LLP, ONE STATE STREET, BOSTON, MA, 02109, US

(73) Assignee: Tyco Healthcare Retail Services, AG

(21) Appl. No.: 11/508,048

(22) Filed: Aug. 22, 2006

(51) Int. Cl. B32B 37/12; B32B 38/04

(52) U.S. Cl. 156/227; 156/256; 156/269

(57) ABSTRACT

A method for manufacturing a single waist panel reattachable absorbent article is provided. The method involves dividing a multilayered chassis into a plurality of individual T-shaped articles such that a horizontal arm of the T-shaped article forms the waist panel and a vertical arm of the T-shaped article forms the crotch region. The T-shaped articles are folded in half by flipping the vertical arm up to the horizontal arm of the T-shaped article. Bonding material is applied on side edges of the waist panel and the side edges of the waist panel are folded and bonded up and over the vertical arm thereby resulting in the reattachable absorbent article.

### BACKGROUND OF THE INVENTION

The present invention relates to pant-like absorbent articles for containing body exudates. More specifically, the invention relates to disposable absorbent articles having a single waist panel having its side edges releasably bonded to edges of either the front or the back absorbent core area, and methods of making such an absorbent article.

Absorbent articles have long been used in daily life by different kinds of users. They are available in many forms, such as diapers for babies, adult incontinence articles, feminine hygiene products, and the like. All of these different absorbent articles serve a common purpose of containing various kinds of body exudates.

A typical absorbent article has an absorbent chassis that includes a top sheet that contacts the body of the wearer, a back sheet that forms the outer portion of the article, and an absorbent core disposed between these two sheets. The top sheet is made from a fluid permeable material that is soft to feel and non-irritable to the skin so as not to cause any discomfort to the wearer. The back sheet is made from a fluid impermeable material so as to block any excess unabsorbed body release from leaking to the outside of the article. The absorbent core is made of an absorbent material which typically includes a Super Absorbent Polymer (SAP) and the like to absorb body exudates. In addition, an acquisition layer may also be present between the top sheet and the absorbent core. This layer prevents localized pooling of fluids by spreading the fluid across the entire area of the top sheet.

The conventional pant-like absorbent articles are defined by a chassis having a back waist panel, a front waist panel and a crotch region. The chassis is made up of a fluid permeable top sheet and a fluid impermeable back sheet. An absorbent core, in the form of a pad, is sandwiched between these two sheets in the crotch region. The crotch region also has a pair of leg openings disposed between the front and the back waist panel. The back and the front waist panels are bonded, sometimes releasably, to each other to form side seams.

U.S. Pat. No. 6,113,717 to Vogt et al. discloses a method of making a refastenable, pant-like, disposable absorbing article by attaching a pair of opposed side panels to the side edges of an absorbent chassis such that they extend laterally outward from and between the front and back waist regions of the article.

However, such articles typically have protruding side seams that may cause discomfort to the wearer. Moreover, the manufacturing process of such absorbent articles is quite complex and requires multiple components or sub-parts to be joined together to form the article. Thus, such articles leave much to be desired from the standpoint of simplicity of construction and ease and economy of manufacture. Moreover, the manufacturing process is also wasteful of materials and resources since a large part of material must be removed and discarded while forming the components of the absorbent article.

Thus, a need exists for an absorbent article that is simple in construction, can be manufactured economically and efficiently without waste, and which provides a good fit, fastening capability and wearing comfort.

Accordingly, it is an objective of the present invention to provide a simple and cost effective method for manufacturing a reattachable pant-like disposable absorbent article with minimum components or sub-parts.

### SUMMARY

To achieve the aforementioned objectives and to overcome the deficiencies of the prior art, the present invention provides a simplified method for manufacturing an absorbent article comprising a single side panel attached to a waist region. The present invention provides a method for manufacturing a single waist panel reattachable absorbent article. The absorbent article is cut from a multilayered chassis comprising a fluid impervious back sheet web, a fluid pervious top sheet web and a plurality of absorbent pads disposed between the back sheet web and the top sheet web. The method comprises dividing a multilayered chassis into a plurality of individual T-shaped articles such that a horizontal arm of the T-shaped article forms the waist panel, and a vertical arm of the T-shaped article forms the crotch region. The T-shaped articles are then folded in half by flipping the vertical arm up to the horizontal arm of the T-shaped article. Bonding material is then applied on side edges of the waist panel. Thereafter, the side edges of the waist panel are folded and bonded up and over the vertical arm resulting in the reattachable absorbent article.

### BRIEF DESCRIPTION OF DRAWINGS

FIG. 1A is a multilayered chassis comprising a back sheet web, absorbent pads disposed on the back sheet web and a top sheet web laid on top of the absorbent pads.

FIG. 1B is a cross sectional view of an individual absorbent article.

FIG. 2 shows rectangular leg holes cut out on the multi layered chassis of the article.

FIG. 3 shows the T-shaped articles after the multi layered chassis has been cut and individual T-shaped articles are placed spaced apart.

FIG. 4 shows the arrangement of individual articles after the articles are placed such that a horizontal arm of the T-shaped article forms a leading edge.

FIG. 5 shows flipping of the vertical arm of the absorbent article onto the horizontal arm.

FIG. 6 shows folding the side edges of the horizontal arm up and over the vertical arm.

FIG. 7 is a method flowchart outlining the steps involved in manufacturing the absorbent article in accordance with an embodiment of the invention.

### DETAILED DESCRIPTION OF THE INVENTION

As used herein, the terms “absorbent article”, “absorbent garment”, or simply “article” or “garment” refer to devices that absorb and contain body fluids and other body exudates. More specifically, these terms refer to garments that are placed against or in proximity to the body of a wearer to absorb and contain the various exudates discharged from the body. A non-exhaustive list of examples of absorbent garments includes pantiliners, sanitary napkins, feminine hygiene products, diapers, diaper covers, disposable diapers, training pants, and adult incontinence products. Such garments may be intended to be discarded or partially discarded after a single use (“disposable” garments). Such garments may comprise essentially a single inseparable structure (“unitary” garments), or they may comprise replaceable inserts or other interchangeable parts.

The present invention may be used with all of the foregoing classes of absorbent articles, without limitation, whether disposable or otherwise. The absorbent article of the present invention is optionally a diaper, pantiliner, sanitary napkin, feminine hygienic garment, incontinent brief, training pant, diaper holder, or combination thereof. The embodiments described herein provide an exemplary structure of a disposable, pant-like diaper article which is adapted to be worn by infants about the lower torso. However this is not intended to limit the scope of the claimed invention. The invention will be understood to encompass, without limitation, all classes, and types of absorbent articles, including those described herein.

The term “longitudinal”, as used herein, refers to an axis or direction in the plane of the absorbent article that is generally aligned with a vertical plane which bisects a standing wearer into left and right body halves when the absorbent article is worn. The term “lateral” refers to the line, axis, or direction perpendicular to the longitudinal direction, which lies within the plane of the absorbent article. The length in the longitudinal axis and lateral axis represent the length and width of an absorbent article.

Throughout this description, the terms “top sheet” and “back sheet” denote the relationship of these materials or layers with respect to the absorbent body. It is understood that additional layers may be present between the absorbent body and the top sheet and back sheet, and that additional layers and other materials may be present on the side opposite the absorbent body from either the top sheet or the back sheet.

The present invention discloses a method for manufacturing single waist panel reattachable absorbent articles. In the absorbent articles disclosed herein, there is only one side panel connecting to edges of either the front or the back absorbent core area.

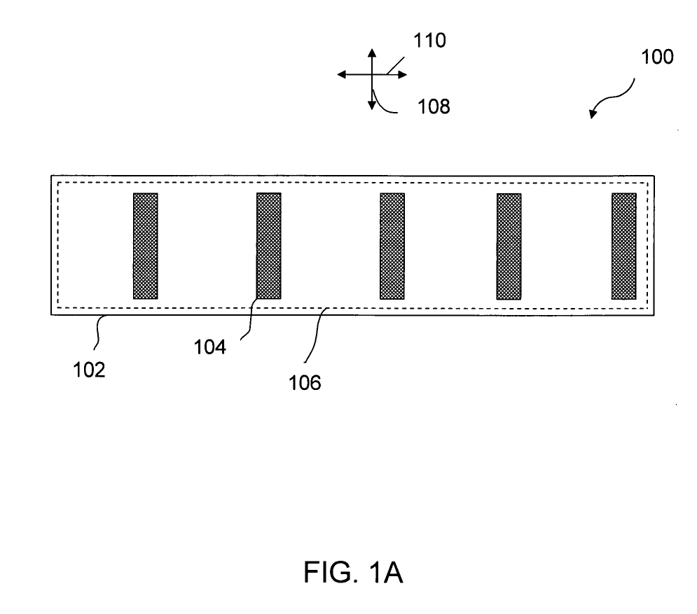

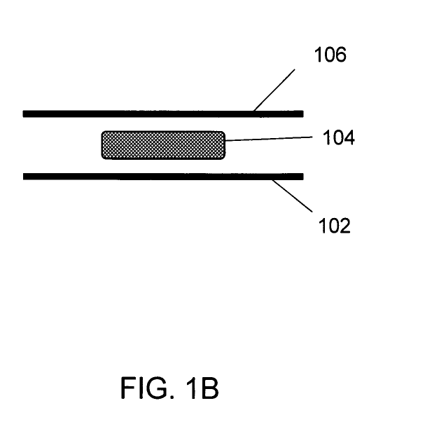

FIG. 1A shows a rectangular multi-layered chassis 100 comprising a back sheet web 102, absorbent pads 104 and a topsheet web 106. Backsheet web 102 is made from a fluid impervious material such as polyethylene or polypropylene. Absorbent pads 104, made up of one or more layers of absorbent materials, are attached to back sheet web 102 at regular spacings. The attachment is done in a manner such that the length of the absorbent pads is parallel to longitudinal axis 108 and perpendicular to lateral axis 110. The distance between two adjacent absorbent pads 104 depends on the required size of the individual absorbent articles. A top sheet web 106 made from a fluid permeable material is then attached on top of absorbent pads 104 and laid on back sheet web 102.

Top sheet web 106 is made from a soft and non-irritable material to avoid any discomfort to the wearer. Therefore, in this arrangement, the absorbent pad is sandwiched between back sheet web 102 and top sheet web 106 to form a multilayered chassis 100. Multilayered chassis 100 is cut into multiple individual absorbent articles: each individual article having a top sheet, a back sheet and an absorbent pad interposed between the top sheet and the back sheet. It will be apparent to one skilled in the art that multilayered chassis 100 may have additional layers disposed between the top sheet web and the back sheet web. For example, in one embodiment, multilayered chassis 100 has a porous acquisition layer incorporated between top sheet web 106 and absorbent pads 104. The acquisition layer in the form of a fibrous wadding, a carded fibrous web or other type of fibrous material can temporarily store fluids before they are finally absorbed by absorbent pads 104.

FIG. 1B shows a cross section view of an individual absorbent article made by cutting the multilayered chassis 100 into discrete articles. Absorbent pad 104 is shown to be sandwiched between the fluid permeable top sheet and the fluid impervious back sheet.

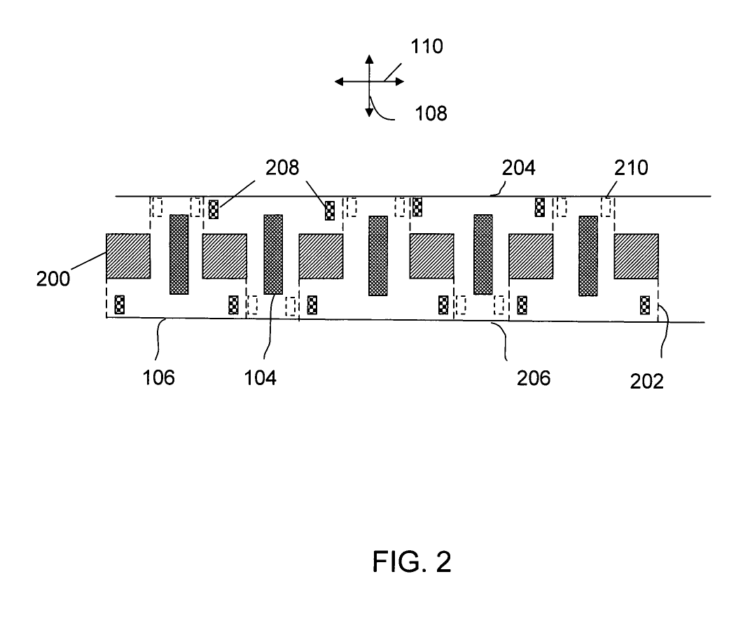

Rectangular holes 200 are cut out from multilayered chassis 100 in between absorbent pads 104 as shown in FIG. 2. In order to cut multi layered chassis 100 into individual articles, cuts are made along the dotted lines 202 as shown in FIG. 2. Each cut starts from a length of multilayered chassis 100 parallel to the longitudinal axis 108, and ends at a vertex of rectangular hole 200. Multilayered chassis 100 is cut so as to form multiple individual T shaped absorbent articles. A horizontal arm 204 of the individual T shaped article forms a waist panel, and a vertical arm 206 of the T shaped article (comprising the absorbent pad) forms the crotch region of the absorbent article when the absorbent article is worn. Horizontal arm 204 may form either a front waist panel or a back waist panel. The waist panels comprise the portions of the article which, when worn, are positioned on the side hip regions of the wearer. Desirably, the horizontal arms or waist panels 204 are elastic or stretchable to provide improved fit about the wearer. For example, horizontal arms or waist panels 204 may comprise a stretch-thermal laminate (STL), neck-bonded laminate (NBL), or stretch-bonded laminate (SBL) material. Horizontal arms or waist panels 204 are desirably capable of elongating in lateral direction 110 for improved fit and comfort. The stretchability of waist panels 204 allows waist panels 204 to stretch over and around the hips of the wearer as the absorbent article is pulled on while still maintaining proper fit at the waist after the article is correctly positioned on the wearer. Adhesive bonding material may also be applied on the side edges of horizontal arm 204 at this stage. In one embodiment, the bonding material is in the form of a fastener grip 208 attached to the side edges of horizontal arm 204. Target devices 210 are provided on the side edges of vertical arm 206 for releasably engaging fastener grips 208.

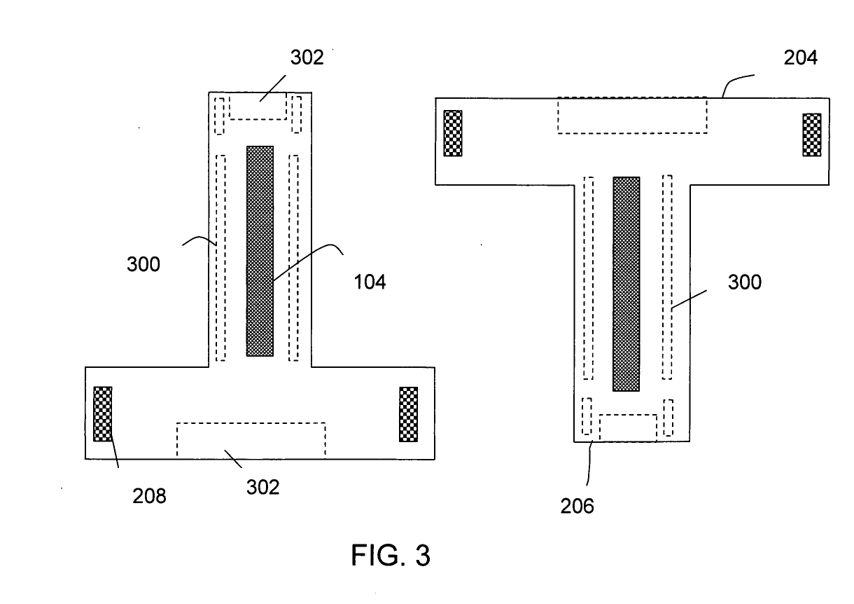

The individual T shaped absorbent articles are then cut and separated as shown in FIG. 3. As FIG. 3 shows, the T shaped absorbent articles may also include a pair of leg elastic members 300 connected to the laterally opposed edges in the crotch region and a pair of waist elastic members 302 connected to the longitudinally opposed edges in the waist region. Leg elastics 300 and waist elastics 302 are generally adapted to fit about the legs and waist of a wearer in use, to maintain a contacting relationship with the wearer and reduce or eliminate the leakage of body exudates from the diaper.

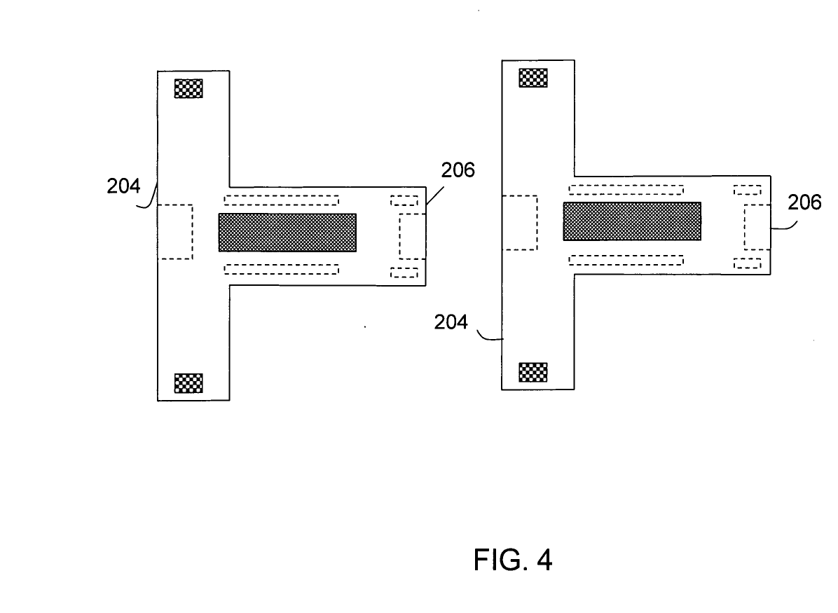

The individual T-shaped absorbent articles are then arranged in a manner such that horizontal arm 204 forms the leading edge as shown in FIG. 4.

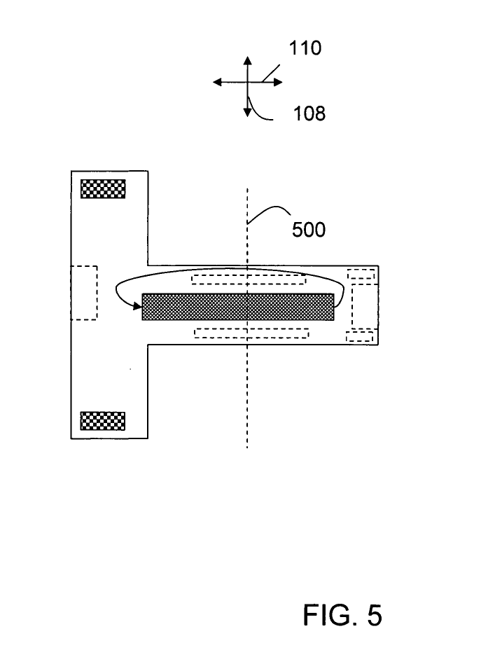

FIG. 5 shows the flipping of vertical arm 206 up to and over horizontal arm 204 of the T-shaped article. The flipping is done about a line 500 extending parallel to longitudinal axis 108 and dividing vertical arm 206 of the T-shaped article into two parts.

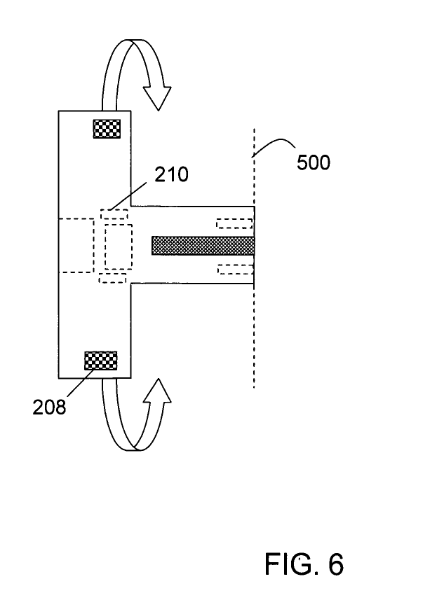

FIG. 6 shows the folding of edges of the waist panel over the vertical arm of the T-shaped article. Fastener grips 208 attached to the edges of the waist panels are releasably bonded to target devices through a bonding material. It will be apparent to one skilled in the art that the bonding may also be done using mechanical and/or ultrasonic means or by a hook and loop arrangement. Further, the bonds may be point bonds, dashed lines, continuous lines, discontinuous lines and combinations thereof. In one embodiment, the material applied on the side edge of the waist panel is perforated. This makes the side edges ‘tear away’ and enables easy removal of the absorbent article from the body of the wearer.

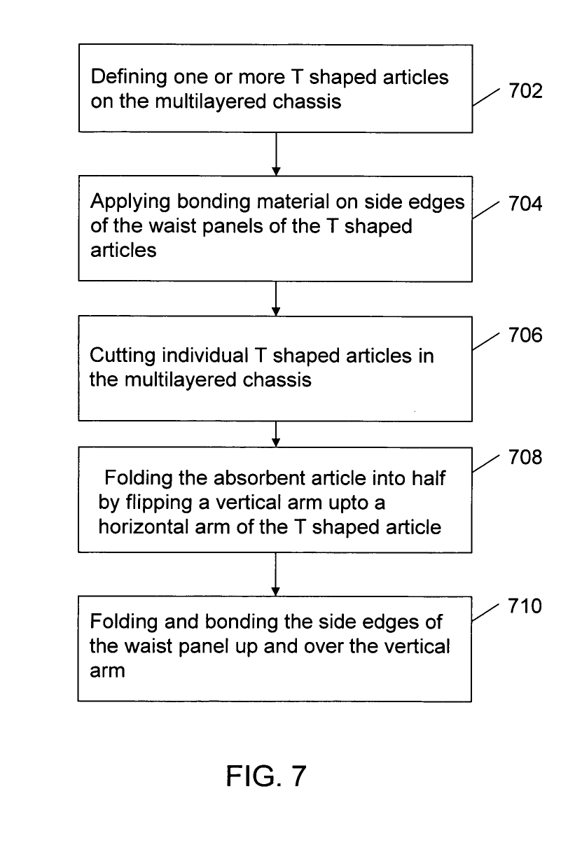

FIG. 7 is a method flowchart outlining the steps involved in manufacturing the absorbent article in accordance with an embodiment of the invention. The absorbent articles are cut from a multilayered chassis comprising a fluid impervious back sheet web, a fluid pervious top sheet web and a plurality of absorbent pads disposed between the back sheet web and the top sheet web. The number of absorbent pads disposed between the back sheet web and the top sheet web corresponds to the number of absorbent articles that can be formed from the multilayered chassis.

At step 702, rectangular holes are cut out into the multilayered chassis. The rectangular holes are cut such that one leg hole is positioned between two adjacent absorbent pads. At step 704 the multilayered chassis is divided into multiple individual T-shaped absorbent articles. This division is made by cutting the multilayered chassis such that a cut extends from a length of the rectangular multilayered sheet to an edge of the rectangular hole. A horizontal arm of the resulting T-shaped article forms a waist panel, and a vertical arm of the T-shaped article comprises the absorbent pad. At step 706, the individual absorbent articles are separated and arranged such that the horizontal arm forms the leading edge. At step 708, the absorbent article is folded in half by flipping the vertical arm of the T-shaped article up to the horizontal arm. At step 710, a bonding material such as an adhesive is applied to the side edges of the horizontal arm. At step 712, the side edges of the horizontal arm are folded up and over the vertical arm. The side edges of the horizontal arm are releasably bonded to the side edges of the vertical arm using a suitable bonding arrangement. It will be apparent to one skilled in the art that different bonding arrangements may be used for bonding the waist panel. In one embodiment a combination of fastener grips and target devices is used for bonding. In different embodiments, adhesives, hook and loop arrangements, mechanical bonds and ultrasonic bonds may be used for such bonding.

In various embodiments of the present invention, back sheet 102 is preferably formed from a laminated sheet of a non-woven material and film. Such material should be hydrophobic, soft in texture, and strong in tensile strength. An example includes hydro-entangled nonwoven webs, which may contain some cotton and/or rayon fibers blended in with thermal-plastic fibers. Cellulose fibers can also be blended in at small percentages to reduce cost. Other materials for forming the back sheet may include polypropylene films, co-extruded films (polyethylene and ethylene vinyl acetate), co-polymer films (polyethylene/polypropylene), and polylaminates (polypropylene nonwoven and polyethylene film). Another example is a film made of a “breathable” microporous polyethylene. This material allows water vapor to pass through it over time, while being impervious to water.

Liquid permeable top sheet 106 may be made from a variety of textile-like films and fabrics. Preferred nonwoven materials include spun-bonded polypropylene, spun-bonded polyethylene, and thermally bonded webs of staple fibers.

Absorbent pad 104 can be made up of any suitable absorbent material, as well as combinations of different types of absorbent materials. For example, the absorbent may be formed of a mixture of pulp fluff and superabsorbent particles wrapped in a liquid permeable tissue wrap. The superabsorbent particles may be substantially homogeneously mixed with the hydrophilic fibers or may be non-uniformly mixed. The pulp fluff may be exchanged with synthetic, polymeric, meltblown fibers or with a combination of meltblown fibers and natural fibers. Examples of superabsorbent materials include polyacrylamides, polyvinyl alcohol, polyacrylates, various grafted starches, and the like. A desired super absorbent material is a cross-linked polysodium acrylate, which can be purchased from BASF Corporation of Portsmouth, Va., under the trademark ASAP 2260.

Leg elastics 300 and waist elastics 302 are optionally provided depending upon the intended use of the absorbent article. Leg elastics 300 and waist elastics 302 function to further prevent leakage of body exudates and support the chassis. Examples of materials used for making leg and waist elastics include sheets or strands or ribbons of a polymeric, elastomeric material, polyurethane, synthetic and natural rubber.

In the foregoing specification, specific embodiments of the present invention have been described. However, one of ordinary skill in the art will appreciate that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or element of any or all the claims. The invention intends to cover all possible embodiments within the boundaries defined by the appended claims.

What is claimed is:

1. A method for manufacturing a single waist panel reattachable absorbent article, the absorbent article being cut from a multilayered chassis comprising a fluid impervious back sheet web, a fluid pervious top sheet web, and a plurality of absorbent pads disposed between the back sheet web and the top sheet web, the method comprising:
defining one or more T-shaped articles on the multilayered chassis wherein a horizontal arm of the T-shaped article forms a waist panel and a vertical arm of the T-shaped article comprises an absorbent pad;
applying bonding material on side edges of the horizontal arm of the T-shaped articles;
cutting individual T-shaped articles in the multilayered chassis;
folding the T-shaped articles in half by flipping the vertical arm up to the horizontal arm of the T-shaped article; and
folding and bonding the side edges of the horizontal arm up and over the vertical arm.

2. The method as claimed in claim 1 wherein defining T-shaped articles further comprises defining leg cutouts into the multilayered chassis, the leg cutouts being placed between two adjacent absorbent pads.

3. The method as claimed in claim 1 wherein the bonding material comprises fastener grips.

4. The method as claimed in claim 3 wherein the fastener grips are releasably engaged to target devices on the side edges of the vertical arm.

5. A method for manufacturing a single waist panel reattachable absorbent article, the absorbent article being cut from a multilayered chassis comprising a fluid impervious back sheet web, a fluid pervious top sheet web and a plurality of absorbent pads disposed between the back sheet web and the top sheet web, the method comprising:
defining rectangular leg cutouts into the multilayered chassis, the leg cutouts being placed between two adjacent absorbent pads;
dividing the multilayered chassis into a plurality of individual T-shaped articles, wherein a horizontal arm of the T-shaped article forms the waist panel and a vertical arm of the T-shaped article comprises an absorbent pad;
folding the T-shaped articles in half by flipping the vertical arm up to the horizontal arm of the T-shaped article;
applying bonding material on side edges of the waist panel; and
folding and bonding the side edges of the waist panel up and over the vertical arm.

6. A method for manufacturing a single waist panel reattachable absorbent article, the absorbent article comprising a fluid impervious back sheet, a fluid pervious top sheet and an absorbent pad disposed between the back sheet and the top sheet, wherein the absorbent article is manufactured from a T-shaped article with a horizontal arm of the T-shaped article forming a waist panel and a vertical arm of the T-shaped article forming the crotch region, the method comprising:
attaching at least one fastening element to side edges of the horizontal arm of the T-shaped articles;
attaching at least one target device on the side edges of vertical arm;
folding the T-shaped articles in half by flipping the vertical arm up to the horizontal arm of the T-shaped article; and
folding the side edges of the horizontal arm up and over the vertical arm,
whereby the target device releasably engages the fastening element upon folding to provide the reattachable absorbent article.

7. The method as claimed in claim 6, wherein the at least one fastening element comprises a hook portion of a hook and loop fastener, and the one or more target devices comprises the loop portion of a hook and loop fastener.

8. The method as claimed in claim 6, wherein the at least one fastening element is an adhesive tape, and the one or more target devices comprises a tape receiving surface.

9. The method as claimed in claim 6 wherein the horizontal arm of the T-shaped article is formed from an elastomeric material.
